(19) United States
(12) Patent Application Publication
(10) Pub. No.: US 2008/0198794 A1
(43) Pub. Date: Aug. 21, 2008

(54) VIRAL-LIKE ELECTRONIC DATA PROPAGATION

(75) Inventors: James A. Fields, Grand Rapids, MI (US); Benjamin P. Knapp, Dorr, MI (US)

Correspondence Address: JAMES E. BARTEK, 3830 56TH STREET, GRANDVILLE, MI, 49418, US

(73) Assignee: PATENT WORKS, INC., Grand Rapids, MI (US)

(21) Appl. No.: 11/676,276

(22) Filed: Feb. 17, 2007

(51) Int. Cl. H04Q 7/00

(52) U.S. Cl. 370/328

(57) ABSTRACT

Data propagation is provided with an originating transmitter that receives and processes data into a data packet that it transmits. A sensory input device is connected with and sends data to the transmitter. A plurality of transceivers are disposed in a geographic space and may receive and retransmit the packet. A target receiver receives and processes the packet and reports a result of processing the data.

### CROSS-REFERENCE TO RELATED APPLICATIONS

This is a continuing non-provisional application of co-pending U.S. Provisional Patent Application Ser. No. 60/______, entitled Method And System For Signal Transmission With Viral-Like Propagation and filed on about 18 Feb. 2006 by James A. Fields et alia, now expired, the disclosure of which is incorporated here by reference.

### BACKGROUND OF THE INVENTION

The present invention relates to a method and a system for the generation and propagation of an electronic information packet. More specifically, the present invention relates to a signal that is generated with a data packet that is capable of being re-transmitted by other like systems until such time as selected parameters have been met.

The advancements that have been made in the field of radio communications have typically paralleled the advancements in other electronic fields. Many times technology has crossed over allowing radio communications to become more effective, efficient, or capable. A few examples of such events include the introduction of satellite radio which uses radio signals that are projected from geosynchronous or satellites, or perhaps even more famously, the miniaturization of radios using transistor technology developed for the space program, further, the introduction of digital tuners are but a few of advancements that have resulted from new technology.

Certainly when one thinks of technology and the impact that specific advancements have had, it is hard to put forward anything that has more of a profound influence in modern society than the introduction of the microprocessor. In essence, the microprocessor is a computer all unto its own, and includes its own operating system with provisions for receiving inputs and for transmitting outputs to other components. The ability to install microprocessors (sometimes termed “CPU's”) into normally benign devices as mundane as a refrigerator, for instance, has revolutionized the way “things” function. The ability to monitor conditions, to react to captured data, and to execute decisions that are made by operating software, including self diagnosis and maintenance, has opened up whole new vistas for applications where embedded intelligence can produce an advantage.

The ability to enhance functionality has not been lost on those involved in the field of radio devices. CPU's have been integrated into various kinds of radio products and are now routinely assisting the user by offering LCD displays, showing information and selection options, by operating various functions within a radio related device, and also by allowing the reduction in size of the product as well. Most of the applications of CPU's to such devices though is targeted toward the duplication of necessary functions by the CPU in lieu of actual hardware. For instance, the tuning of an FM radio no longer requires specific tuner hardware since this can be accomplished using integrated circuitry that is controlled by the CPU. The user merely interfaces with the display generated by the CPU to select the desired radio station and the rest is accomplished without the need for any moving parts of any kind.

Other devices have profited from the advent of microprocessor technology, for example, Global Positioning Satellite (GPS) devices are now available and offer a user the ability to pinpoint their location within a matter of feet, if not inches. The interpolation of the satellite data beamed to the hand held unit is handled easily by its included CPU as is the massaging of the collected data into a real-time display. In some device, the route that a person might be traveling is actually saved into memory for later playback.

In some respects the deployment of such technology has served to enhance the core functionality of such devices, and in other cases whole new categories of devices have resulted from the application of microprocessor technology to a specific field of endeavor. One problem that has remained, however, is a basic limitation on the ability of radio wave transmission. The usual relationship between the viability of radio transmission and distance to a receiver is proportional to the power that is imparted to the radio transmission. Thus the so-called pirate radio stations of the 1950s and 1960s that established transmitters of 50,000 watt strength (or more) has the advantage of reaching out over large distances and broadening the scope of their potential audience. Since that time, the power of radio broadcasting, as well as the availability of select frequencies, has been tightly regulated by the FCC and the result is that limitations have been placed on power output for the reason that the proliferation of a large number of powerful radio broadcasts on the same frequency (or even on frequencies that are close) would create interferences and render reception impractical in many ways. Thus the use of a fairly reliable means of communication has been limited because of restraints placed on it by both government and also the practicality (or lack thereof) of managing a large number of powerful radio transmissions.

While the deployment of low wattage satellite radio has helped to broaden the scope of transmissions without adversely affecting the user (and without running afoul of the FCC) such transmissions are really based upon the same radio model that has been in existence since the days when Marconi first started transmitting to ships plying the Atlantic. This model is simply one of “A to B” transmission where the source generates a signal that is meant to be received by all who select that frequency—a discretionary audience—and where the successful receipt of the transmission depends on the proximity of the receiver and the strength of the transmission. In fact, the information that is provided by the signal, or at least the nature of the information, namely, streaming audio or video and the like, has remained relatively unchanged as well and is comprised of news, entertainment, and at times, information that is specifically relevant to the group of listeners.

The usage of other types of radio transmissions for other purposes is known. For instance, the EPIRB (Emergency Position Indicating Radio Beacon) is used in maritime applications as a tool for locating vessels in distress. If a user finds themselves in a situation requiring emergency assistance from the Coast Guard, for example, they can activate the EPIRB which then sends out a signal that is recognized as an emergency beacon by the Coast Guard. Using radio triangulation, the Coast Guard can obtain a fix on the position of the sender and send such help as may be required. This transmission model is still of the “A to B” type and is reliant on the same factors as discussed above.

It is recognized by all, that a radio transmission that can be propagated over longer distances per unit of power would clearly be advantageous. In addition, a radio transmission that could effectively impart information (data packets or packets) without disturbing other radio transmissions would also be desirable. Lastly, the leveraging of CPU technology to enhance the handling of radio transmissions beyond the level of an operational interface between the user and the radio functions is essentially unrealized in the prior art and would be of great advantage.

### BRIEF SUMMARY OF THE INVENTION

Accordingly, a method of viral-like electronic data propagation of the invention comprises the use of a low wattage radio transmission “source,” where the source is integrally mated with a CPU and an instruction set. The instruction set for the CPU will prepare a “data packet” for transmission by the source where the data packet is typically coded in a format that is not reproduced as “noise” by any receiver that may be set on the same frequency as the source. Complementing the source is a “target” which is a receiver that is adapted to recognize the signal as containing the data packet and thereafter decoding the data packet. The target, in accordance with the present invention, may be subject to its own instruction set which will act appropriately to retransmit the data packet in a manner that is consistent with the parameters set forth in the data packet or in the instruction set.

Preferably, the target of the present invention will cause the data packet to be retransmitted under the same type of conditions employed by the source. Thus any secondary receiver will then be able to capture the retransmitted signal and decode it in the same fashion as the primary receiver, and in the norm, will thereafter retransmit the data packet under the same type of conditions as employed by the source and as repeated by the primary receiver. Thus, the data packet may thereafter be received by a tertiary receiver where the same process is duplicated and the retransmission of the data packet continues.

The data packets of the present invention may include multiple components as far as the actual information that may be included for transmission. Components may be generated automatically by the source, or information may be manually imparted for inclusion into the data packet.

These and other features, objects, and benefits of the invention will be recognized by one having ordinary skill in the art and by those who practice the invention, from this disclosure, including the specification, the claims, and the drawing figures.

### BRIEF DESCRIPTION OF THE SEVERAL VIEWS OF THE DRAWING

FIG. 1 is a diagrammatic representation of a method of signal transmission of the present invention;

FIG. 2 is a diagrammatic representation of signal propagation of a type that may be generated in use of the present invention;

FIG. 3 is a flow chart representation of a system for receiving and transmitting a signal using method(s) of the present invention;

FIG. 4 is a diagrammatic representation of a data packet of the present invention;

FIG. 5 is a diagrammatic representation of one type of signal processing that may occur when using the method of the present invention; and

FIG. 6 is a diagrammatic representation of another type of signal processing that may occur when using the method of the present invention.

### DETAILED DESCRIPTION OF THE INVENTION

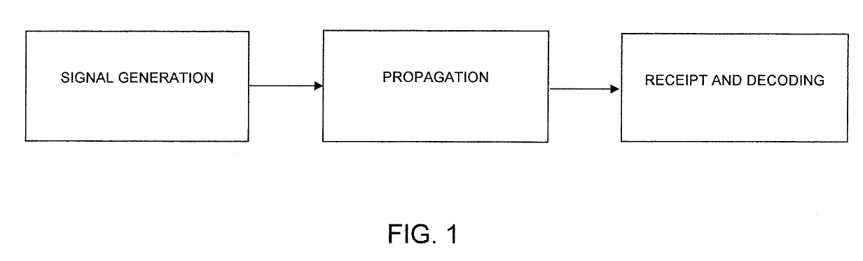

An exemplary preferred embodiment of a method of viral-like electronic data propagation according to the invention is shown in the drawings and is discussed in detail with this specification. In a simplified embodiment, the signal transmission system is shown generally in FIG. 1 and schematically represented, including signal generation, propagation, receipt, and decoding. The signal transmission of the present invention is initially discussed herein as being carried by radio waves, although the same principles can equally apply to other forms of transmission, including optical (laser, fiber optic) and other electrical or magnetic transmission modes. Radio wave transmission may be considered effective in the instant case since it can be easily produced and using the principles of the present invention, it can be used to propagate the signal over very long distances and to a very large audience of potential receptors.

Using radio wave transmission as a preferred medium, a signal is preferentially carried on a low wattage radio frequency. The selection of this medium represents in part the opportunity that exists to leverage a part of the radio broadcast spectrum that is commonly used for unregulated broadcasts of many kinds, including walkie-talkie, baby monitors, etc., and also because the hardware that is needed for such radio transmissions is well known and readily available. Typically the wattage used in these applications is less than five watts which results in a carrier for the signal that may have typical effective ranges of up to about two miles, although greater ranges may be experienced depending on environmental circumstances. Additional range may be obtained by utilizing more wattage (disregarding for the moment whether or not such increase in power transmission would be regulated or not) and also by varying the frequency spectrum that might be selected. For the purposes of the preliminary discussion here, the present invention would be illustrated for use in an unregulated spectrum and power range, or otherwise without regard to regulatory limitations.

The generation of the signal to be transmitted is understood by one skilled in the art and does not specifically form a part of the present invention, although the content of the signal does play a part in the way the invention works and its usefulness. Suffice to say that when a particular radio frequency is selected for transmission, compatible hardware for this parameter is chosen. The content of the signal and how the signal is handled from the point when it is transmitted is discussed sequentially below.

### The Signal

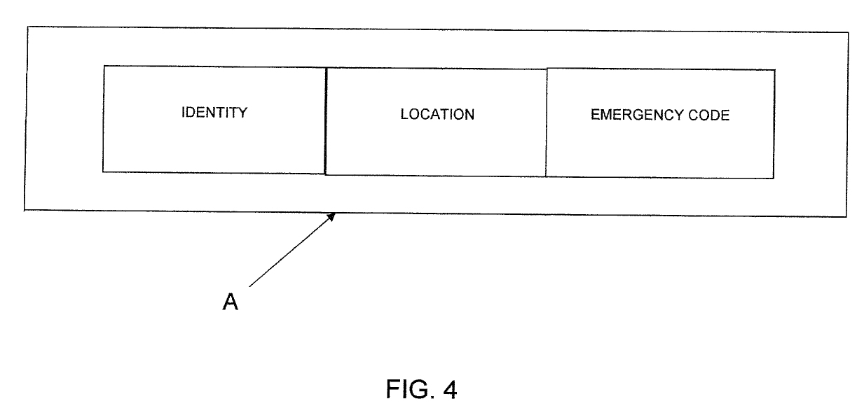

The signal may comprise a carrier and a data packet that is formatted for compatible transmission (and reception). The carrier, as the term is used herein, applies to the medium of the signal, which in a preferred mode, may be a low wattage radio wave. Other modes of signal transmission may include audio, optical, laser, or any other medium or method that may be or become known to one skilled in the art. The data packet may vary with the application in which the present invention is used. Typical data packet information that is coded for transmission may include identity, location, name, license number, date, emergency status, etc. Reference to FIG. 4 shows a representation of a data packet that includes three categories of information, namely, identity, location and emergency code as shown. In this instance, the application for use may relate to an emergency signal that has as its objective, the notification of emergency personnel as to the existence of an emergency condition, where that condition resides, and the name of the party or the license number of a vehicle involved. The degree of information that may be included in a data packet is discretionary and outside of practical limitations there is no real limit as to the number of categories, the degree of detail, or the type of information that may be coded into a data packet for signal transmission.

Preferably the data packet is encoded as digital code that can be thereafter processed by a receiver that is compatible with the decoding or the retransmission of the data packet. An advantage of digital encoding is that it has enhanced accuracy over analog signals (such as voice recordings) that may frustrate interpretation if the signal fades. Digital signals may be checked for parity to ensure that the complete message is received by a receiver, which may confirm the contents of the data packet as being accurate. The message may then be recognized by the receiver and processed. This advantage is important in terms of accurate propagation of the signal as will be discussed further below.

The data packet may be generated automatically or it may have some component that is inserted manually by a user. In a typical case, the source from which the signal is generated may provide an automatic signature to any data packet that is prepared for transmission. Usually This signature may include such information as identity of the source and this may break down further into the name of the user, the vehicle identification number associated with the source, the license number associated with the source, or other such information that may be desired as part of the identity package associated with the source. This may include all of the foregoing information as well; the amount and type being within the discretion of one who would set up the system in the first instance. The user may also desire to include categories of information that may be set manually; these may include purpose information types such as a need for emergency assistance, for a tow truck, for a police response, for activation of alarms, and a myriad of other possible categories of information types that may be desired under various implementations. The information is useful, however, if it is compatible with the processing of the signal by the complementary receiver as will be discussed further below.

The data packet must be compatible with transmission on the carrier for the signal. In a preferred mode of practice, this may be a low wattage radio wave as indicated above, although the principles apply equally to any other mode of signal transmission. Applications of the use of the data packet in the context of the present invention will be discussed further below.

### Processing

The signal may be transmittable by conventional means for the type of signal selected, which in the present example is radio transmission. Thus, the signal in the preferred mode is subject to receipt by a radio receiver. A preferred system is premised upon a combined transmitting and receiving unit, a transceiver, although the two components or tasks may be separated in some applications of the invention as will be discussed further in this specification. Nonetheless, receipt of the signal is central to its processing which includes several steps.

The first stage of processing is to identify the signal as being one that is recognized. As mentioned above, the usage of encoded data helps in this stage since the particular code being used may be consistent both in transmission and reception. If the signal is recognized, then it can be broken down into its components which typically commences with source identification. Following this, other components of the data packet may be comprehended by the receiver. Each component may then be handled in accordance with the instruction set provided for the CPU which will dictate whether or not some components are stored in short term memory or if they are acted upon immediately, or whether any other action is to be taken. Initially, the components of the data packet signal may preferably be registered as having been received. Commonly, the receiver may be used mainly as a means to propagate the signal verbatim, utilizing and incorporating a transmitter. Thus the receiver or transceiver, may usually not be subject to any particular responsive action when the data packet is received.

At this point one who considers this specification of the invention may also consider that a useful aspect of the invention may include defined characteristics of the data packet. More specifically, one characteristic of a data packet may be its ability to be configured with multi-faceted or multi-layered security. That is to say that a data packet may be encoded or configured with a spectrum of information from what may be considered “public” information to what may be considered “secret’ information, incorporating respective levels of encoding. Information of a nature of routing information, that is information that is needed for a data packet to be transmitted to its target destination, may be considered public information. Civilian emergency response request information and vehicle identity or license plate information, for example, may also be considered public information. Some identity information, including personal identity information rather than vehicle identity, may raise to a higher level of security than public information and may be categorized as “private” information. Further, information of the nature of “national security” information may be an extreme example of what may be considered “secret” information. However a user of the invention may desire to classify information incorporated in a data packet, it is clear that various levels or degrees of encoding and thereby security may be used in configuration of a data packet to serve a particular purpose of a given data packet.

Again, a data packet may typically merely be retransmitted. As such the processing is primarily functioning as part of a “repeater” system, although that may not entirely describe all of the functions that may take place within the system. With reference by way of example to the security features above, a minimal level of processing of a data packet by a receiver may include interpretation of so called routing information to determine whether mere repeating of the data packet or further processing is appropriate. Thus, a data packet may be subject to processing by a receiver, and if it is desired to do so, the receiver may be provided with appropriate instructions to interpret the data packet and to act on the information that it contains. In some cases, resulting action may include at least one of the following, which listing is not exclusive and is merely suggestive:

A) archiving of the received information;

B) modifying the received information;

C) attaching the received information to a new data packet and transmitting;

D) converting the received information for display or output;

E) responding to the received information; and,

F) discriminating among various received information.

The processing of data packet information may typically occur with a specific objective in mind. For instance, if the objective relates to locating the source of the signal, then the processing may include conversion of the information into readable location information, including coordinates on a GPS map. The processing of the information is preferably relevant to the receiver, in that the receiver must employ appropriate instructions to be able to process the signal, which may require that the receiver is in the hands of an entity or user who may respond to the data packet and will need the results of the processing. Again using the same example, if the receiver is in the hands of emergency or search-and-rescue personnel, presently commonly known as “first responders,” then the receiver may process the information in the data packet to provide guidance for locating the sender, who may be requesting first aid or other assistance. Again referring to the multi-level characteristic nature of the present inventive data packet signaling, the data packet may also provide the nature of the purpose that the data packet was generated and transmitted by its originating user, including some level of detail or specifics of this exemplary request for first aid and the like.

The last item mentioned in the list of actions that the receipt of a data packet may trigger within a receiver is discriminating among various received information. This function is a comparative function wherein a receiver may check the received information and if it has been previously handled, for example, then the receiver may discard the information and not retransmit the signal. This discrimination function may be set to allow for a number of receipts of the same signal (which is entirely plausible since the signal source will usually repeat the signal as perhaps other receivers will do within the same area) before “turning it off.” This function, among others that may be placed into the processing of the signals, may preclude the signal being handled into perpetuity. This example is only one of a multitude of uses of what may be considered “discriminatory evaluation” that may be included in the inventive data packet signaling of the invention. The discrimination function may alternatively include a processing of a data packet to compare a present packet time code with a prior packet time code to evaluate whether the present packet is merely a repeat of the prior packet or is a subsequent packet and may indicate that response was not made to the prior packet.

### Propagation

It is the repeater type process of the inventive data packet signaling of the invention that facilitates the transmission of the signal far beyond the direct broadcast parameters of the carrier mode of the signal which in the case of a low wattage radio signal may under various conditions be only a matter of several hundred feet to several thousand feet. Each receiver of the invention is preferably capable of encoding the data packet and most receivers will be given instructions to replicate the signal and retransmit, providing the aforementioned repeater propagation. This promotes transmission by geometric progression of the original signal and serves to broadcast the signal far from its source, notwithstanding the limitations of a transmission method selected. So long as there are a suitable number of receivers disposed upon a desired geography, the inventive process of data packet signaling quickly and comprehensively broadcasts the desired information.

In this fashion, propagation of a data packet occurs in a manner not unlike a “virus” which will replicate its genetic code in an interim host and then broadcast copies of that information to be received by secondary hosts where the process is repeated, with the information then being broadcast to tertiary hosts, and so on. While the propagation analogy is similar to a viral model, the present data packet signaling is distinct in that data packets and receivers of the invention will most preferably incorporate provision, including an instruction set, for terminating propagation of signals upon attainment of specified conditions.

The intention or purpose of a source when originally generating and transmitting a data packet signal is to reach a receiver of defined characteristic. This target receiver may be any of various receivers that can respond or may be more specific to a certain receiver, such as one that may be self-identified as an emergency receiver, or a law enforcement receiver, or even more specific. Thus the signal may be characterized by its intended use and the data packet may carry this information that will be recognized when the signal is processed. For instance, if the signal is transmitted with the intention of reaching a receiver associated with law enforcement, the signal may be replicated by each non-law enforcement receiver that handles it, retransmitting to new receivers until a target, law enforcement receiver is obtained. At this point, the law enforcement receiver may decode the information in the data packet, recognize the information provided, and take respond with appropriate action.

The propagation function of the present invention is reliant upon an ability of the signal to be repeated, unlike other forms of signal transmission that rely on a proportionate level of power to further the range of the broadcast. Contrary to conventional “A to B” forms of signal transmission, the present inventive data packet signal propagation under conditions of low power may allow broadcast over virtually infinite distances with unregulated transmitters and transceivers, so long as compatible equipment is located within effective ranges. This method of propagation uniquely may allow broadcasting to occur over distances that are normally the sole province of regulated signal transmissions, i.e., FM, AM, shortwave, etc.

Another benefit of data packet signal propagation of the invention is the speed with which packet propagation or disbursal may occur. The receipt of a data packet signal, decoding, and retransmission occur very nearly at the processor speed of the CPU. While some delay may accrue with each replication of the signal, such may not amount to significance in terms of the time it would take the signal to be repeated to a receiver where it would be recognized and handled or precipitate a response. The fact that the data packets contain a discrete message in a relatively small part of the signal means that critical information regarding a situation may be transmitted quickly and effectively and for long distances.

It is further noted that the propagation method considered in the present invention is not entirely dependent on a high density receiver population. One of the attributes of the present invention may be that the signal transmission may continue sending the data packet containing the desired information. The transmitter that originates a given signal may or may not be cognizant as to whether or not the signal has in fact been received by a receiver. Alternatively, a system for acknowledging receipt of a signal may be included within the signal source so that confirmation of the receipt of the signal may thereafter cause the originating signal transmission to terminate. A possible limitation to terminating the originating signal transmission, however, is that propagation of the signal may tends to be more certain with multiple receipts of the signal. Thus terminating the originating signal transmission may provide less than optimal performance. In this regard, the originating signal transmission may preferably continue until multiple receipts may be noted. Alternatively, a user may find utility in termination of the originating signal transmission after a single receipt with reinitiating the originating signal transmission after a period of time. Of course, one having ordinary skill in the art understands that these examples are merely some of a spectrum of approaches, including hybrids of these approaches. In any event, an initial receipt of a signal does commence the propagation sequence.

A strategy regarding signal transmission and receipt may take into account a possibility that a signal may be transmitted under conditions where receipt potential is intermittent. For example, a motor vehicle fitted with a transmitter of the present invention may be stranded in a remote location during night time hours. This may occur, for instance, on a highway where traffic is very light. Signal transmission may be continuous in that data packets are sent with some predetermined or otherwise triggered frequency, which may include a method by which the so called stranded transmitter may sense a proximity of a passing receiver. One having ordinary skill in the art understands that this is only one of various energy saving scenarios for a stranded vehicle situation and the like.

When an occasion happens that the originating signal is received by a passing vehicle, the transmitter may optionally be directed to continue signal generation until a selected number of additional receipts may be documented or acknowledged. This means that retransmission of the signal will be made by that number of vehicles that travel by the stranded source. Each of this selected number of vehicles, or secondary transmitters, then retransmits the information as they venture farther along the highway. The same sequence of events may take place with respect to the secondary transmissions emitted by these vehicles, which leads to another group of receivers, a tertiary level, taking in the signal and then re-transmitting. The process continues until the signal reached its desired destination, which may likely be an emergency responder according to this exemplary scenario.

While it may, at first consideration, seem cumbersome, the system is relatively efficient. The signal is carried from remote locales to locales where the population density of the receivers is greater. As soon as a greater density zone is reached, the signal is propagated ahead of the vehicle that is retransmitting the packet, so that the data is moving faster than the vehicle, until it reaches the desired target.

The receipt of the signal by the desired target may not necessarily terminate the signal transmissions that are happening, though it may. In one anticipated scenario, as alluded to above, the target may issue a new data packet, namely, a global receipt signal, which may then be received by any of the receivers to be retransmitted by each and which may be purposed to void the original signal, causing its retransmission to cease. The global receipt signal may include a limitation on how many times a receiver retransmits it.

In some cases the global receipt signal may not reach all of the actively involved receivers and the software provided with the receivers may, upon the attainment of a set period of time, a preset number of retransmissions, or perhaps some other parameter that may be selected, self terminate retransmission. This ensures that signal propagation may continue for a period of time that is sufficient to reach the target receiver, while at the same time providing for the elimination of the signal from retransmission ad infinitum.

The basis for the propagation lies in the ability to digitally transmit the data packets. In an analog context, the data packet messages can be distorted and the content altered upon repeated re-transmissions. Using a digitally based signal, however, each transmission is an exact copy of the original, thus alleviating the traditional “telephone call” scenario for garbling messages.

### Archiving

An archiving function has been alluded to above and is explained in more detail within this section. The ability to recognize data packets and to process messages and information that are contained in each packet, allows a receiver to handle the data in many different ways and do so simultaneously. Thus, the same data may be prepared for retransmission while at the same time be selected for storage (archiving) within a memory of the receiver. Archiving may have at least two discrete functions. First is to store the data in a retransmittable form so that it may be retransmitted as called for, and the second mode is the storage of data for analysis and reporting purposes.

In one aspect, archiving of data for retransmission may be desired since multiple retransmissions may be used to ensure that the broadcast of the source's signal is indeed received by the target. Thus, data derived from the data packet may be handled for an interim period until the receiver has instructions to delete it. While the data may be stored in a format that is appropriate for retransmission, one having ordinary skill in the art understands that one who implements data packet signaling of the invention, a system architect, say, may determine what information is to be relayed and what information may be stripped from the data packet. Some information, including the identity of the source, GPS coordinates, or emergency requests may be types of information that may be desirable to preserve, while information of an incidental or extraneous type, including outdoor temperatures, passwords, and the like, may be selectively stripped from a data packet for storage and avoid storage of inappropriate data.

The archives held by each receiver will therefore contain a lot of information as the receiver passes through areas where active transmissions are occurring. It is envisioned that much of what is received and held in memory will be information that will not precipitate any particular action on the particular system that is holding the information, or any receiver that subsequently receives the same information by retransmission. Nonetheless, the archived information may remain important if only for the reason that it lays down a history that can be checked later, much like the video recorders that seem to purposelessly record the goings-on in retail stores and the like, until something happens. This history may be, upon the receipt of an appropriate command, downloaded to another receiver for further processing. Alternatively, data packets may be designed and configured according to their particular originating purpose to acquire and carry a history of their transmission path, although this may result in data packets growing undesirably large.

Certainly an advantage of an archiving function may be to time-date information that is stored. This function may be accomplished easily with known CPUs and instruction sets and may provide confirmation of data from a real time standpoint. If such data is later processed, the time-date stamp may be passed along with the data packet information, allowing a better picture into the nature and quality of the information when it is processed. For instance, downloading of stored information may be completed by a target receiver. The information may include location and emergency data. The source signal also include in a data packet, a time of the origin of the signal origination. A time-date stamp on retransmitted data packet may provide information as to when data had been received by an intermediate receiver. This may provide some indication about the “freshness” of the information to the target.

In another example without limitation of the invention, raw information such as a vehicle identification number (VIN) of a particular vehicle may be the subject of a data packet. Storage of this information within a receiver may then persist for weeks or months before it being called for upon a command by the target. In this instance, the movements of an identified vehicle, tracked by its VIN number, may be traced and if the information is related to law enforcement action, then it may provide details about a crime and the location and movement of vehicles associated with the event that would not otherwise be known.

The archiving function of the present invention may, thereby, render a receiver into a passive witness to events. Accuracy of information collected may rise to a very high standard because the devices contemplated by the present invention may be simple enough to be installed in new cars and trucks, in rental vehicles, and in fleets of private vehicles used in a business. The type and quantity of the information tracked may be limitless and be shaped to meet the needs of the particular user.

### Termination

Propagation of a signal through the methods of the present invention has potential for flooding receivers with massive amounts of replicate information. The receivers therefore need to be able to discriminate amongst signals that are replicates. A method for terminating retransmission of signals that meet a set of parameters is also useful to avoid or manage “clutter” or “noise” signal propagation. The present invention may so manage data packet signal propagation with appropriately structured processing of the signals.

If, for instance, a particular signal that is received is a duplicate of a previous transmission that was received by the same receiving unit, then the unit operating system or other unit controls, including software and firmware, may provide for comparison of these two packets and, if determined to be duplicate, discarded of the duplicate without further action, including the base task of retransmission or repeating. A receiver may also include instructions to assess stored data and make decisions about continued retention, providing a memory self maintenance feature or routine.

For instance, if a target receiver issues a global command signifying receipt of an identified data packet, receivers that receive this command may delete the identified data from memory. Instructions for each receiver may also or alternatively include predetermined deadlines regarding disposition of stored data. Thus, upon occurrence of a deadline, a receiver's software may evaluate certain stored information to be no longer eligible for storage, that is “stale,” and cause stale information to be deleted. Additional self monitoring or maintaining parameters may optionally be implemented as a user may desire. One who reads this specification will thereby appreciate that various transmitters, receivers, and transceivers of the invention maybe tailored to fit particular objectives and approaches of users in various applications or implementations of the present invention.

With the foregoing discussion in mind, one may turn to the drawings and appreciate the diagrammatic representations of the present invention. An exemplary, though not limiting, basic format for the unique signal handling of the present invention is shown in a gross overview in FIG. 1. The source signal may be generated, then propagated, and then received and decoded. In what may be considered a daisy-chain approach, an elegant solution presents a profound treatment of a signal that would otherwise likely be limited in range and in quality of information carried for long distances.

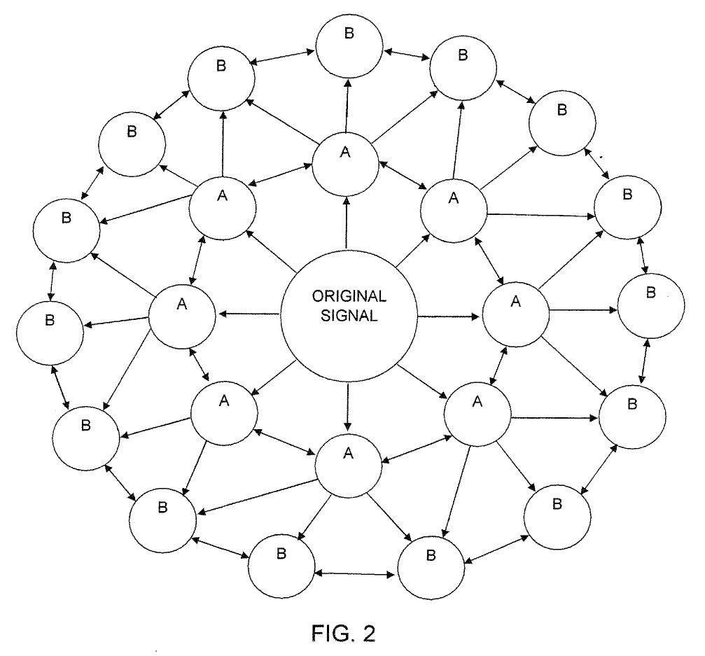

A representation of a propagation cycle contemplated by the present invention is shown in FIG. 2. The signal is shown as being sourced near the center of the diagram with a first tier of receivers that receive and retransmit the signal shown as receivers “A.” Propagation of the signal to a subsequent next tier of receivers is shown by receivers “B,” which may receive the data signal from other receivers B within their same tier or from receivers A, as shown. Each of any of the receivers may further receive multiple replicate signals from any other proximal receiver. It is also understood that the representation is not meant to be literal or otherwise limiting. Retransmission of the source signal may, and typically will, continue on for a number of rebroadcasts or additional tiers of receivers, with the objective of being received by a target receiver, where the data or information packet contained in the signal, will have the desired consequence.

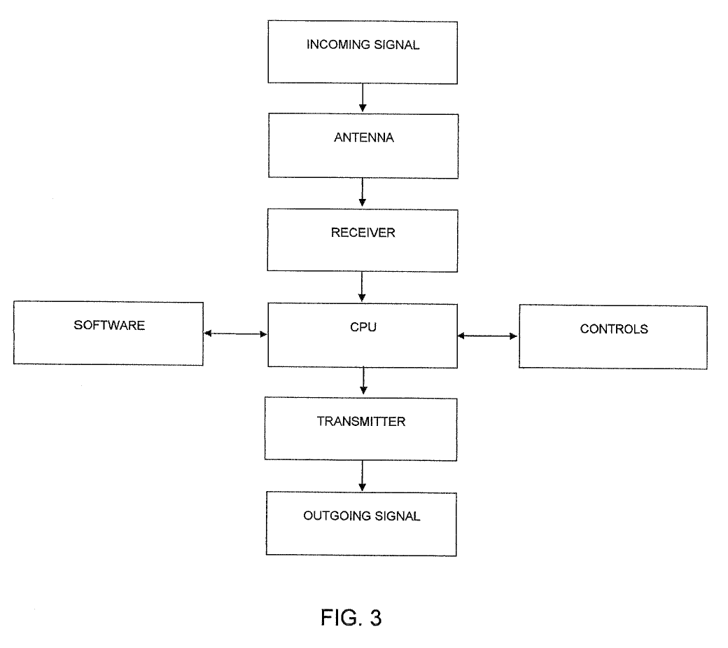

A schematic representation of a receiver of a preferred embodiment of the invention is shown in FIG. 3 with an incoming signal handing sequence initiating with reception into the receiver, continuing through the CPU where it is decoded, and ending with the data packet of the incoming signal retransmitted. As discussed above, there are occasions when copies of the data packet or components of the data packet may more preferably be manipulated for storage, for activating other actions, or other purposes of the system design.

A data packet is shown in FIG. 4 in what may be considered a “genetic” aspect of the data packet. Again analogizing the data packet to DNA, each data packet preferably has its own digital makeup, which allows it to be distinguished while at the same time providing a recipient with information or data that fulfills a design objective of the present invention as implemented in a user specified embodiment. In the example shown, a fundamentally concise data packet may be comprised of an “Identity” code, a “Location” code, and an “Emergency” code, which codes are transmittable by the source. The Identity would refer to the signal source and may include a number of pieces of information which would assist others in determining who the sender is or what the sender is. For instance, the Identity may optionally include any or all of a number of pieces of information, such as a person's name, a vehicle identification number, a person's social security number, or any other tracking identifier that a user may be useful. The Location parameter may include a location coordinate, including a cell phone grid location, GPS coordinates captured from a GPS unit connected with the source at the time the data packet is created, identity of a farm or ranch associated with the user, a zip code, or any location information a user may elect to use. Lastly, the Emergency Code may comprise a request for assistance that is coded in a way that the target receiver will comprehend, or a factual statement concerning a status of the source. As is appreciated from this disclosure, many forms of coding may be used to form a message of the inventive data packet signaling of the invention and the examples given are by no means exhaustive of this potential or limiting the invention.

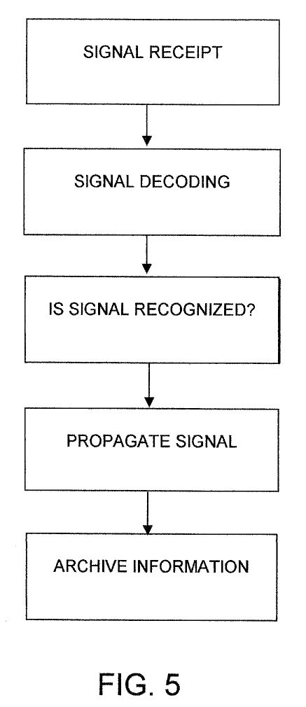

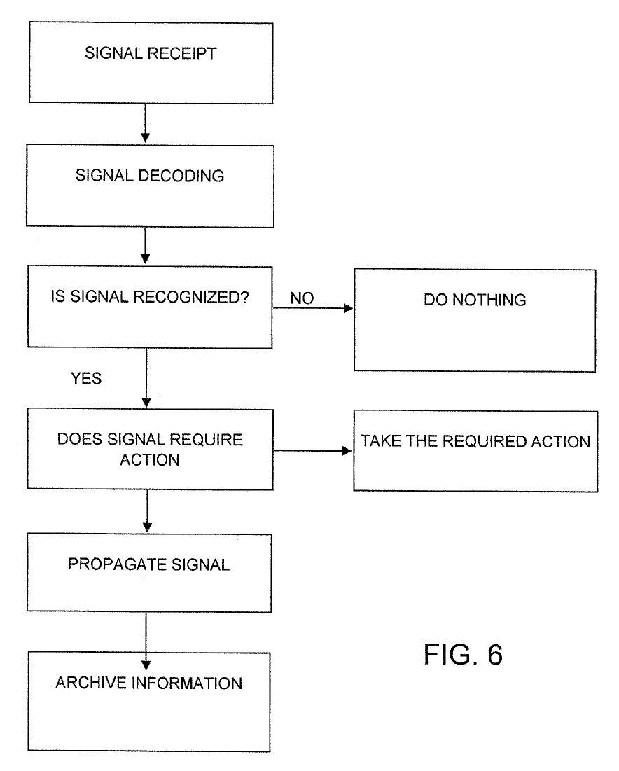

Two types of receivers that may be envisioned within the scope of the present invention are suggested in FIGS. 5 and 6. A receiver may, as seen in FIG. 5, be a passive witness to events. More specifically, the schematic shows that the receiver in this instance collects the signals and, aside from some modest interrogation, simply causes the signal to be retransmitted. Optionally, the essence of the data contained in the signal may additionally be archived. This passive system aspect may be found useful in some foreseeable uses of the present invention, including operation as a law enforcement tool and in other uses where a competently record data log that may be desirable.

In contrast, a more active, non-passive receiver is represented in FIG. 6, at least insofar as the received signal may be used to activate other actions on the part of the receiver or otherwise. The propagation and archiving functions may optionally be desired here and may be implemented by an architect of the system for each particular implementation. The reactive aspect of this version may, however, typically be found to be included in target receivers, which is where one may expect a response to particular information or instructions in the data packet.

The digital makeup of the data packet, it is understood, must be compatible with the receivers, especially a target receiver, so that it may be understood. The content of the source signal, eventually finding its way to the target receiver, will be evaluated and when an action is required, the target receiver may send a new signal with the object of causing various responsive events, such as:
A) The target's signal may merely be sent to notify the source that the message has been received. Alternatively, additional information may also be sent;
B) The target's signal may be a call for specific action from multiple alternative or additional target receivers, as may be desired in the nature of a coordinated emergency response;
C) The target's signal may also include a “termination” message that is recognized by all receivers and which causes termination of further retransmission of the source signal.
   The actions of the target receiver as described may include additional steps beyond the ones set forth above, this being dependent upon the architect of the system and selected system objectives.

Various models have been suggested for the implementation of the present invention. Several models will be discussed herein, which are meant to illustrate the potential applications that exist for the concept, however, these illustrations are by no means the exclusive applications of the invention which has very wide ranging potential that is dependent only upon the person who is desirous of leveraging the benefits of the present invention.

### Search and Rescue

Many times search and rescue teams are deployed to locate skiers lost in avalanche, lost hikers, lost children, boats, to name just a few such missions. Some devices are known for these situations where a radio beacon is generated upon the occurrence of the event, such as the sinking of a boat, or a skier covered under an avalanche. This radio beacon is reliant upon a broadcast range that is proportionally limited to its power. Thus the use of the present invention has the benefit of increasing the range of the signal without the need for a substantial power supply. In fact, the power source for the present invention can be minimized since the data packets are only intermittently transmitted thereby reducing the amount of power actually needed. In addition, the data packets for a source transmitter are continuously being transmitted in many instances, which obviates the need for a person to have a clear head in the event of a disaster such that they are able to remember to turn on the radio beacon.

The data packet will ideally give out location information, typically tied to GPS, which will help any responders to easily locate the source and to perfect a rescue. In some cases though, it is enough to know “who” is still unaccounted for in a disaster, such as skiers who may still be missing after an avalanche where the target receiver is showing a number of identified persons.

One of the attributes of the present invention is the fact that deployment of the source transmitter in locations that are remote still provides for an efficient means for signal data propagation. For instance, a snowmobiler may become stranded on a trail far from a lodge. Other snowmobilers may be traversing the area, within range of the source transmitter, and their receivers are able to pass this information along (through retransmission) to a responder without requiring affirmative response from the passing snowmobilers. In extremely remote conditions, it is understood that the occurrence of casual passers-by may have a low likelihood, and in those circumstances the output power for the source transmitter can be increased accordingly. Even though this happens, the viral propagation of the signal is still an effective and efficient means to broadcast a message.

### Law Enforcement

The use of a source transmitter in a law enforcement model has numerous potentials. In one version, the source may act as a passive witness, discussed above, and archive data on an ongoing basis. When an event requiring law enforcement intervention occurs then a target receiver, likely used by the law enforcement agency, is able to retrieve stored data on its own system relative to an inquiry, and it can poll other receivers in the vicinity as well for the same information. For instance, it may have been reported that a vehicle (with an installed receiver) with a particular license plate was seen leaving the location of the crime. This information can be coordinated with the VIN number associated with that vehicle and all of the receivers in the area can be polled about the VIN number. Where information is found, it is uploaded back to the target receiver and using the other embedded parts of the original signal data, the time and place of the subject vehicle can be noted with a high degree of accuracy. This helps to provide a history of where the vehicle has been (important for prosecution) as well as identifying the possible location of the vehicle at the present time.

Another law enforcement application involves a source transmitter that is integrated with a motor vehicle. Aside from the identification component in the data packet, information unique to the particular vehicle can be communicated to the receiver and used to form a piece of information that is subject to transmission. For instance, the speed of the vehicle can be the subject information piece that is communicated which is relatively easy given the state of OEM automotive electronics. As one might suspect, the speed information can be transmitted to a target receiver, in this case a patrol car, which would then have a near real time indication appear showing the subject vehicle to be speeding (or not). The system can be refined enough to coordinate GPS locations with the speed limits so that only violations will be displayed at the target receiver. Extending the example even further, knowing the VIN number of the vehicle, the violation can be recorded, and then later printed and mailed to the violator saving the patrol officer time and effort, and keeping the officer on the road for more of his/her time.

Aside from the obvious angst that some of the applications of the present invention may have (especially with those who are veteran speed violators) the tremendous amount of value in the forensic information that can be collected and retrieved using this concept is formidable. It would be possible to track the escape path of a bank robber, or to locate a fugitive known to be driving a particular vehicle, or the names and addresses of witnesses to an accident, as well as the potential circumstances involved in an accident. The wealth of information that can be mined might have been considered to be overwhelming in past years, but with the advent of cheaper and faster computing power this does not represent a barrier any longer.

### Service and Delivery

The use of the method of the present invention can be applied to business practices such as service or delivery providers. For instance, a service provider such as a repair business will have a number of vehicles on the road at a given time either on their way to an account, or visiting an account, or just leaving an account. Coordinating these separate vehicles and drivers can be accomplished using the system described herein. The status of each driver and vehicle is updated both automatically (GPS coordinates, vehicle identification, etc) and also though manual inputs such as information regarding the account (service commenced, service completed, service suspended, etc). The target receiver is able to receive the information on a near real time basis and then cause messages to be transmitted in the nature of dispatch orders, advising each driver where to go next and who to seem and the like.

Obviously a similar scenario can be deployed for delivery businesses. The target receiver acts as a dispatcher and keeps track of the progress of orders throughout the course of the day. The business can organize the deliveries in the most efficient manner using the method and also have a continuous history of the deliveries that have been, where they were made, and at what time they were made.

One of the benefits associated with the signal transmission system of the present invention is that in application of the service and delivery type, there is a concurrent deployment of vehicles. Knowing the density of the vehicle population within the territory will help in setting the range of the radio transmission needed to ensure the receipt and retransmission of signals. This relationship also ensures that the relay and receipt of information is virtually real time.

### Air Traffic

The present invention can also be applied for use as a tool for aircraft control. The data packets will contain information regarding the identification of the aircraft, the location, and any other information that may be helpful with respect to air traffic control. In this instance, the transmission power may have to be adjusted to a larger range in order to provide optimal conditions for receipt by other aircraft. As indicated, other aircraft can receive the transmitted information which can then be displayed in a manner to show the position and identification of the other aircraft. Unlike RADAR, the present system can supplement the detection of the other aircraft with information relating to the speed, heading, intended destination, type of aircraft, etc. The objective is to increase the amount of the information that is available which should, as an adjunct, increase safety.

The target receivers in this model include other aircraft, but will also include airport towers as well. They can supplement their usual tracking systems with the supplied information, which may then be possible to match up with flight plans for known aircraft. As was the case before, this system will automatically provide a history of transmissions and receipts that once archived can later be mined for multiple purposes. For instance, if a plane is lost or overdue, an inquiry can be made to determine where it had been, at what time, and where it was heading. This information would greatly increase the efficiency of search and rescue missions by reducing the search zone tremendously.

### Other Applications

The signal transmission system of the present invention can be utilized in numerous other applications as well, ranging from medical institutions, hikers and backpackers, department stores, corrections, warehousing and logistics, nursing homes, to name just a few. The low cost of the units coupled with the low wattage radio usage that can be utilized in most applications, negates the disadvantages of other approaches for these uses that would be cost prohibitive or less efficient.

Other media may be used for the present invention as well. Infrared transmission is certainly possible, optical, audible, or any other media where a signal can be sent and thereafter interpreted. The utilization of digital data packets opens the transmissions up to retransmission and to automation which negates the need for burdensome two-way talking transfers of information.

One having ordinary skill in the art and those who practice the invention will understand from this disclosure that various modifications and improvements may be made without departing from the spirit of the disclosed inventive concept. One will also understand that various relational terms, including left, right, front, back, top, and bottom, for example, may be used in this detailed description of the invention and in the claims only to convey relative positioning of various elements of the claimed invention without limitation to the invention.

What is claimed is:

1. A method of electronic data propagation, comprising:
providing an originating transmitter unit that is adapted to construct an electronic data packet and to transmit the data packet;
providing a plurality of transceiver units that are adapted to receive and transmit the electronic data packet, whereby at least one of the plurality of transceiver units receives the data packet and retransmits the data packet, so that at least another one of the plurality of transceiver units receives the data packet and retransmits the data packet with; and
providing a target receiver unit that is designated in the data packet as a target recipient of the data packet, the target receiver unit being adapted to receive the data packet, to process the data packet, and to report a result of processing the data packet.

2. The method defined in claim 1, wherein each of the plurality of transceiver units is one a mobile transceiver unit and a stationary transceiver unit.

3. The method defined in claim 1, wherein the data packet is embedded with at least one of identification information, location information, and status information.

4. The method defined in claim 1, wherein the data packet is embedded with unencoded public information and with encoded nonpublic information.

5. A method of electronic data propagation, comprising:
providing an originating transmitter unit;
providing an electronic data packet;
adapting the originating transmitter unit to transmit the data packet;
transmitting the data packet;
providing a plurality of transceiver units;
adapting each of the transceiver units to receive and retransmit the electronic data packet;
disposing the plurality of transceiver units upon a geographic area;
providing a target receiver unit;
adapting the target receiver unit to receive the data packet;
adapting the target receiver unit to process the data packet; and
adapting the target receiver unit to report a result of processing the data packet.

6. The method defined in claim 5, wherein each of the plurality of transceiver units is one a mobile transceiver unit and a stationary transceiver unit.

7. The method defined in claim 5, wherein the data packet is embedded with at least on of identification information, location information, and status information.

8. The method defined in claim 5, wherein the data packet is embedded with unencoded public information and with encoded nonpublic information.

9. A method of electronic data propagation, comprising:
providing an originating transmitter unit;
adapting the originating transmitter unit to receive data;
providing a sensory input device;
adapting the sensory input device to send data to the originating transmitter unit;
operatively connecting the sensory input device with the originating transmitter unit;
adapting the originating transmitter unit to process the data into a data packet;
adapting the originating transmitter unit to transmit the data packet;
transmitting the data packet from the originating transmitter unit;
providing a plurality of transceiver units;
adapting each of the transceiver units to receive the electronic data packet;
adapting each of the transceiver units to retransmit the electronic data packet;
disposing the plurality of transceiver units in a geographic space;
at least one of the plurality of transceiver units receiving the transmitted data packet;
at least one of the at least one of the plurality of transceiver units receiving the transmitted data packet transmitting the data packet;
providing a target receiver unit;
adapting the target receiver unit to receive the data packet;
adapting the target receiver unit to process the data packet;
adapting the target receiver unit to report a result of processing the data packet.

10. The method defined in claim 9, further including the steps of:
at least one of the plurality of transceiver units not receiving the transmitted data packet from the originating transmitter unit;
the at least one of the plurality of transceiver units not receiving the transmitted data packet from the originating transmitter unit receiving the transmitted data packet from one of the at least one of the at least one of the plurality of transceiver units that received the transmitted data packet and that transmitted the data packet; and
the at least one of the plurality of transceiver units not receiving the transmitted data packet from the originating transmitter unit transmitting the data packet.

11. The method defined in claim 10, wherein each of the plurality of transceiver units is one a mobile transceiver unit and a stationary transceiver unit.

12. The method defined in claim 10, wherein the data packet is embedded with at least on of identification information, location information, and status information.

13. The method defined in claim 10, wherein the data packet is embedded with unencoded public information and with encoded nonpublic information.
